(19) United States
(12) Patent Application Publication
(10) Pub. No.: US 2014/0073295 A1
(43) Pub. Date: Mar. 13, 2014

(54) INTERCEPTION OF DATABASES

(71) Applicant: Telefonaktiebolaget L M Ericsson (PUBL), Stockholm (SE)

(72) Inventor: Amedeo Imbimbo, Caivano (NA) (IT)

(73) Assignee: Telefonaktiebolaget L M Ericsson (PUBL), Stockholm (SE)

(21) Appl. No.: 14/023,591

(22) Filed: Sep. 11, 2013

Related U.S. Application Data
(63) Continuation of application No. 11/722,849, filed on Jul. 22, 2008, now abandoned.

(51) Int. Cl. H04W 12/02

(52) U.S. Cl. CPC H04W 12/02
USPC 455/411

(57) ABSTRACT

The present invention relates to problems how to generate information related to access and use of a directory object in a database. The problems are solved by methods and arrangements in a communication system to generate information related to use of the monitored directory object in a database. An interception Access Point (IAP) provides information to an Intercept Configuration Unit (ICU), The information is associated to the monitored directory object. The method comprises receiving to the IAP a request to monitor the directory object in the database; detection of use of the monitored directory object in the IAP; and, delivering information related to said use from the IAP to the Intercept Configuration Unit ICU.

### CROSS-REFERENCE TO RELATED APPLICATIONS

This application is a continuation of U.S. Application No. 11/722,849, filed Jul. 22, 2008, which was the national stage of International Application No. PCT/SE2004/1002047, filed Dec. 29, 2004, the disclosures of which are incorporated herein by reference.

### TECHNICAL FIELD OF THE INVENTION

The present invention relates to methods and arrangements in a communication system to provide information related to use of a directory object in a database.

### DESCRIPTION OF RELATED ART

In modern communication networks different databases are important elements. They provide support for all kind of applications that could be distributed on different Application Servers. One example of data is user data for a subscriber, e.g. if the user has a call forwarding service activated.

One example of a database in a communication network is the Home Subscriber Server. It is, as defined in 3GPP R6, the master database for GSM and WCDMA users. It provides support for user security, authorization, mobility management, roaming, identification and service provisioning for Circuit Switched (CS) domain, for Packet Switched (PS) domain, for WLAN access to WCDMA (as defined in 3GPPP R6) and for the IP Multimedia subsystem. The Home Subscriber Server could be used for any application developed in the Service Layer. An Application Server in the Service Layer could ask for and receive data, for the execution of a certain service, from the Home Subscriber Server, e.g. what kind of service that is activated on the users subscription.

A subscriber may have the possibility to modify its user data (e.g. activation of call forwarding service) by dialling a specific code or number. The signalling from the user equipment to the database goes through the local exchange in case of a fixed line or the MSC node in case of a mobile user.

It is also possible to let the user, the subscriber, to have access to its user data in a database server via an Application Server in the Service Layer. The access to the Application Server could for example be via Internet Networks. The procedures between the Application Server and the data base server can be executed by means of for example, the LDAP protocol or the Sh interface based on the Diameter Protocol.

There is a demand to monitor access and use of services in a database at the same level of security and confidentiality as known from traditional communication services.

One way to monitor Communication Services is Lawful Interception, i.e. the act of intercepting a communication on behalf of a Law Enforcement Agency. Interception of traditional communications Content of Communication i.e. speech and data is known. Interception of Intercept Related Information is also known. Intercept Related Information is defined as signalling information related to target subscribers, for example call establishment. As an example, in Circuit Switching domain, the sending of IRI to a monitoring function is triggered by the following call-related and non-call related events:
Call Establishment
Answer
Supplementary Service
Handover
Release
Subscriber Controlled Input

Appropriate session related and session unrelated events trigger the sending of IRI to a monitoring function in case of Packet Switching communication.

The procedures used by the subscriber to modify its user data in the database (e.g. activation of call forwarding service) are today intercepted in the fixed local exchange for fixed line subscribers or in the MSC node for mobile users.

According to current Lawful Interception standards, it is not possible to report, by means of existing Intercept Related Information events, the access and use of services in a database when the database is accessed via an Application Server in the Service Layer.

### SUMMARY OF THE INVENTION

The present invention relates to problems how to generate information related to access and use of a directory object in a database.

The problems are solved by associate an Interception Access Point IAP to the directory object in a database and generate new properly structured information.

In more detail the problems are solved by methods and arrangements in a communication system to generate information related to use of the monitored directory object in a database. The system provides the information to an Intercept Configuration Unit ICU The information is collected from the IAP, which is associated to the monitored directory object in the HSS. The method comprises the following step:
receiving to the Interception Access Point IAP a request to monitor the directory object in the database,
detection of use of the monitored directory object in the IAP,
delivering information related to said use, from the IAP to the Intercept Configuration Unit ICU

Advantages of the invention are that use of a directory object in a database can be monitored.

The invention will now be described more in detail with the aid of preferred embodiments in connection with the enclosed drawings.

### BRIEF DESCRIPTION OF THE DRAWINGS

FIG. 1 discloses a block schematic illustration of a communication system comprises a Home Subscriber Server HSS, an Application Server and an Intercept. Configuration Unit ICU.

FIG. 2 discloses a block schematic illustration of an Intercept Configuration Unit ICU in the communication system.

FIG. 3 discloses a flow chart illustrating some essential method steps of the invention.

### DETAILED DESCRIPTION OF EMBODIMENTS

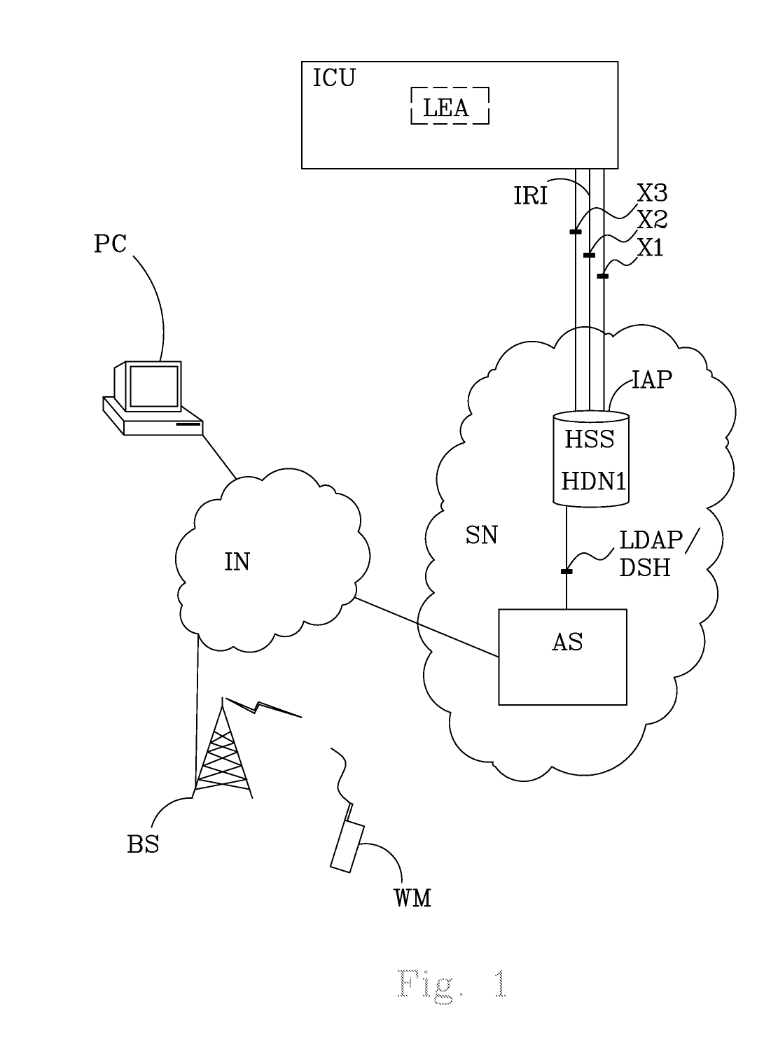

FIG. 1 discloses a communication system comprising a Service Network SN. The SN hosts a Home Subscriber Server HSS and an Application Server AS.

The Application Server AS could host all kind of services and subscription for a user. The Home Subscriber Server HSS is, as defined in 3GPP R6, the master database for GSM and WCDMA users. It provides support for user security, authorization, mobility management, roaming, identification and service provisioning for Circuit Switched (CS) domain, for Packet Switched (PS) domain, for WLAN access to WCDMA (as defined in 3GPPP R6) and for the IP Multimedia subsystem. The HSS could be used for any application developed in the Service Layer. An Application Server in the Service Layer could ask for and receive data, for the execution of a certain service, from the HSS, e.g. what kind of service that is activated on the users subscription. The data for a specific user is stored under a directory object that has a unique name, HSS directory name, i.e. subscriber profile name. A directory object with the HSS directory name HDN1 is stored in the HSS. HDN1 comprises at least some user data for a subscriber or user. The HSS is configured as an Interception Access Point IAP.

The Application Server AS can communicate with the Home Subscriber Server HSS by the means of the protocol LDAP or Diameter Sh DSH. Other protocols could also be used.

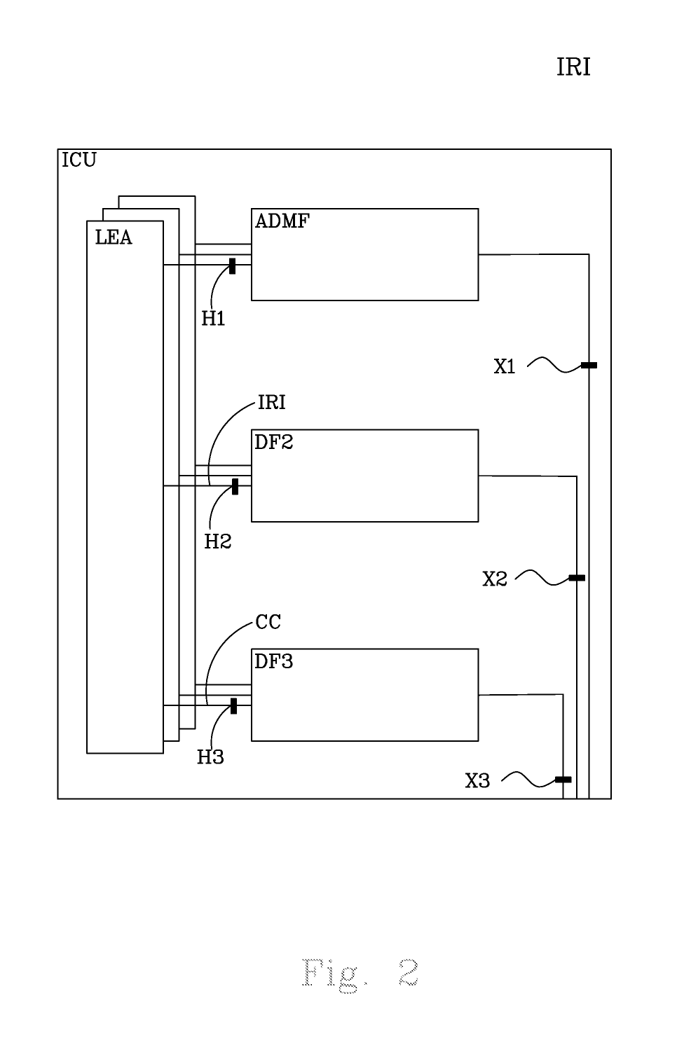

An Intercept Configuration Unit ICU is connected to the HSS/IAP. The ICU is connected to the node via three interfaces X1, X2 and X3, The ICU and the interfaces will be further explained in FIG. 2.

The communication network also comprises Internet Networks IN, A computer PC is connected to the IN.

A WAP-mobile WM is also connected to the Internet Networks IN via a base station BS.

The Intercept Configuration Unit ICU is disclosed in FIG. 2. The ICU comprises at least one Law Enforcement Agency LEA (three blocks representing different LEAs are shown in FIG. 2), Each LEA is connected, via interfaces H1-H3, to three Mediation Functions respectively for ADMF, DF2 and DF3, i.e. an Administration Function ADMF and two Delivery Functions, a so-called second Delivery Function DF2 and third Delivery Function DF3. LEA is connected to the ADMF via interface H1, to the DF2 via interface H2 and to the DF3 via interface H3. The Administration Function and the Delivery Functions are each one connected to the communication network via the interfaces X1-X3. The ADMF is connected via the interface X1, DF2 is connected via X2 and DF3 is connected via X3. The Administration Function ADMF is together with the delivery functions used to hide from the network that there might be multiple activations by the different Law Enforcement Agencies. The messages sent from the ADMF to the network via the X1 interface comprise identities of the subscriber/equipment that is to be monitored, i.e. target identities. The second Delivery Function DF2 receives Intercept Related Information RI from the network and DF2 is used to distribute the IRI to relevant Law Enforcement Agencies. The third Delivery Function DF3 receives Content of Communication CC, i.e. speech and data, and is used to distribute the CC to relevant LEAs. DF3 is responsible for call control signalling and bearer transport for an intercepted product.

Intercept Related Information IRI, received by DF2, is defined as signalling information related to monitored subscriptions.

Sending of Intercept Related Information IRI to a monitoring function is triggered by Events, these are either call related or non-call related. Call establishment is an example of a call related Event and Location update is an example of a non-call related Event. Access to a directory object, e.g. user data of a subscriber, in a HSS is an Event that could trigger the sending of IRI to the ICU.

According to an embodiment of the invention, the already existing Events have been enhanced to include also monitoring of use of a directory object in a database, in this example a Home Subscriber Server HSS. If a user access a directory object in the HSS, the Interception Access Point. IAP, i.e. the HSS, sends relevant data to DF2. This will later be explained in more detail. Examples of parameters in the IRI report when a directory object in the HSS is accessed are as follows:
HSS Access Protocol. The protocol used to access the directory object, LDAP or Diameter SH
HSS Operation: All protocol operations will be conveyed in this parameter, e.g. LDAP Message in case of LDAP or Commands in case of Diameter-Sh.
HSS Directory Name: The name of the directory object that is accessed.

It is to be observed that those parameters above are only examples of possible parameters in the IRI report related to access to a directory object in the HSS.

In this embodiment of the invention the user has a telephony subscription and at least some of his user data stored in the HSS directory name HDN1. The user access HDN1 in the HSS via Internet Networks IN and a computer PC. He will activate the service call forwarding and forward his phone calls to number 12345. The target of the interception will be the directory name HDN1. The protocol used to access HDN1 is LDAP in this example.

The HSS is configured as an IAP. The HDN1 associated to the Interception Access Point IAP, i.e. the HSS.

A method according to this embodiment of the invention will now be explained in more detail. The explanation is to be read together with FIGS. 1 and 2. The method comprises the following steps:
The Law Enforcement Agency LEA sends via interface H1 a request to the

Administration Function ADMF to activate interception of user data stored at the HSS Directory Name HDN1. This means that directory object HDN1 will be monitored, it will be target of the interception.

The ADMF forwards via interface X1 a target identity of the directory object HDN1. to the Interception Access Point IAP/HSS.
A user access the Application Server AS from a computer PC via Internet Networks IN. He forwards a request to activate call forwarding.

The Application Server AS communicates with the database HSS by the means of LDAP protocol. The Application Server AS provides the name of the directory object HDN1.

The provided HSS directory name HDN1 is identified by the IAP/HSS as an intercepted target.

The IRI parameters HSS directory name, Le, HDN1, HSS Access Protocol, i.e. LDAP and HSS Operation, i.e. access to HDN1 and activate call forwarding to number 12345, are sent as Intercept Related Information IRI from the IAP to the Delivery Function DF2 via interface X2.
The IRI is forwarded from DF2 to the LEA via interface H2.

Other steps are possible. For example there might be a step of identification of the user. The user does not have to be the subscriber himself, anyone could access the database and change a users profile. The steps above could also come in another order. It is e.g. flexible at what step the IAP will send IRI to the DF2.

The user access the Application Server AS from a PC. Any device that could access an AS could be used, another example is a WAP-mobile WM.

The access to the Application Server AS is in this example via Internet Networks. Any type of access to the AS could of course be possible.

The directory object HDN1 stores in this example user data for a subscriber. Any kind of data could of course be stored in the HDN1.

In the case of data related to a subscriber, the subscription could be of any type, e.g. data or telephony. This embodiment of the invention has activating call forwarding as an example, but of course any services or access to data in the HDN1 will be possible to intercept. Examples of communication with a database that could be intercepted are activating or de-activating, subscribe or unsubscribe and interrogating of any kind of service or subscription. Changes of users profile e.g. address change or changes of the billing method are other examples of data that could be intercepted.

The database, i.e. the HSS, could be situated and hosted anywhere in the network. HSS is of course one example of a database. Any database connected to the network would be possible. A database does not need a dedicated server but could be hosted by any node in the network. That node will then be the Interception Access Point IAP.

LDAP is one example of possible protocol to use for the access to the directory object in the HSS. Another example is Diameter-Sh. In the case of use of LDAP as HSS Access Protocol the HSS Directory Name corresponds to the LDAP Directory Name, HSS Operation will be coded as LDAP Message as specified in LDAP, RFC 2251. Examples of operations are bindRequest and bindRespons. In the case of use of Diameter-SH as HSS Access Protocol, HSS Operation will be coded as Commands as specified in TS 29.329 V6,1.0. Examples are User-Data-Request and User-Data-Answer.

The parameters in the IRI report mentioned above are only examples and other parameters are possible. Time and date of the operation are other examples of IRI parameters. If the access to the HDN1 fails, an Access Failure Reason could be forwarded from the IAP via the DF2 to the LEA. If an access code is used, that code could also be sent as IRI. It is also not necessary to include all events mentioned in the method above, just one IRI could be enough.

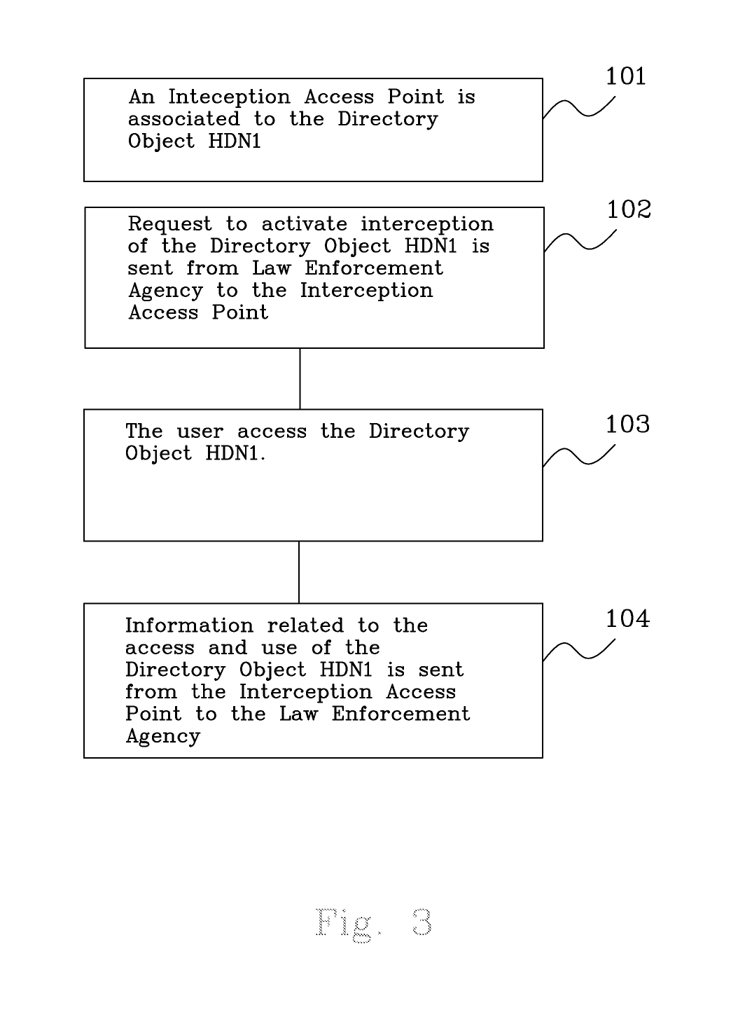

FIG. 3 discloses a flowchart in which some more important steps are shown. The flowchart is to be read together with the earlier shown figures. The flowchart comprises the following steps:
The Directory object HDN1 is associated to an Interception Access Point. A block 101 discloses this step in FIG. 3.

The Law Enforcement Agency LEA sends a request to the Interception access point, to activate interception of the directory object HDN1. A block 102 discloses this step in FIG. 3.

The user access the directory object HDN1. A block 103 discloses this step in FIG. 3.

Information related to the access and use of HDN1 is sent from the IAP to the LEA. A block 104 discloses this step in FIG. 3

The invention is of course not limited to the above described and in the drawings shown embodiments but can be modified within the scope of the enclosed claims.

1. (canceled)

2. A method in a communication system to generate information related to access and use of a directory object in a database, said system configured to provide to an Intercept Configuration Unit information collected from an Interception Access Point, wherein the Interception Access Point is associated to the directory object, said method comprising the steps of:
receiving a request to monitor a directory object at the Interception Access Point, wherein the directory object comprises user data related to static subscription settings for a telecommunication service;
detecting use of the directory object at the Interception Access Point; and,
delivering information related to said use of the directory object from the Interception Access Point to the Intercept Configuration Unit.

3. The method according to claim 2, wherein the Intercept Configuration Unit comprises a Law Enforcement Agency attached to an Administration Function, said method further comprising:
sending from the Law Enforcement Agency to the Administration Function the request to monitor the directory object; and,
forwarding the request from the Administration Function to the Interception Access Point.

4. The method according to claim 2, wherein the protocol used to communicate with the directory object is at least one of the following:
Lightweight Directory Access Protocol, LDAP; and,
Sh interface based on the Diameter protocol.

5. The method according to claim 2, wherein the information delivered from the Interception Access Point to the Intercept Configuration Unit comprises at least one of the following data:
protocol used to access the database;
operation towards the database;
name of the database; and,
name of the directory object.

6. The method according to claim 2, wherein the directory object is stored in a Home Subscriber Server.

7. The method according to claim 2, wherein the communication system further comprises an application server and the directory object is accessed via said application server.

8. The method according to claim 7, wherein the application server is accessed via an Internet network.

9. An arrangement in a communication system to generate information related to access and use of a directory object in a database, said system configured to provide to an Intercept Configuration Unit information collected from an Interception Access Point, wherein the Interception Access Point is associated to the directory object, said arrangement comprising:
means for receiving a request to monitor a directory object at the Interception Access Point, wherein the directory object comprises user data related to static subscription settings for a telecommunication service;
means for detecting use of the directory object at the Interception Access Point; and,
means for delivering information related to said use of the directory object from the Interception Access Point to the Intercept Configuration Unit.

10. The arrangement according to claim 9, wherein the Intercept Configuration Unit comprises a Law Enforcement Agency attached to an Administration Function, said arrangement comprising:
means for sending from the Law Enforcement Agency to the Administration Function, the request to monitor the directory object; and,
means for forwarding the request from the Administration Function to the Interception Access Point.

11. The arrangement according to claim 9, wherein the communication system further includes means for communicating with the directory object, wherein said means is at least one of the following:
Lightweight Directory Access Protocol, LDAP; and,
Sh interface based on the Diameter protocol.

12. The arrangement according to claim 9, wherein the information comprises at least one of the following data:
protocol used to access the database;
operation towards the database;
name of the database; and,
name of the directory object.

13. The arrangement according to claim 9, wherein the directory object is stored in a Home Subscriber Server.

14. The arrangement according to claim 9, wherein the communication system further comprises an application server and the directory object is accessed via said application server.

15. The arrangement according to claim 14, wherein the application server has means to be accessed via an Internet network.
